(19) United States
(12) Patent Application Publication
(10) Pub. No.: US 2005/0122543 A1
(43) Pub. Date: Jun. 9, 2005

(54) System and method for custom color design

(76) Inventor: Eric Walker, Weymouth, MA (US)

Correspondence Address: VISTA PRINT USA INC., 100 HAYDEN AVENUE, LEXINGTON, MA, 02421, US

(21) Appl. No.: 10/729,162

(22) Filed: Dec. 5, 2003

(51) Int. Cl. G06K 15/00; G06F 15/00

(52) U.S. Cl. 358/1.18; 358/1.15

(57) ABSTRACT

Electronic document design systems and methods allowing a user to generate many different color image versions from a grayscale-based image. Grayscale images are stored as patterns and applied as pattern fill of markup language shapes. When a grayscale image is applied as pattern fill, the original black and white color components of the grayscale image are replaced with the two colors specified by the pattern fill element and a color version of the image based on the two colors is displayed to the user as the content of the shape. By changing the colors associated with the pattern fill element, many different color variations of the image can be produced and displayed for user review. One or more color selection tools are provided to allow the user to select different pairs of colors to be used to generate color image versions.

### FIELD OF THE INVENTION

The present invention relates generally to computer-implemented automated electronic product design.

### BACKGROUND OF THE INVENTION

Many individuals, businesses, and organizations occasionally have a need for custom materials, such as birth announcements, party invitations, product or service brochures, promotional postcards, personalized holiday cards, or any number of other items. Some of these individuals and businesses turn to sources such as a local print shop for assistance in preparing the materials. Those having access to a suitable computer may perform the product design process themselves using any of the various specialized software products available for purchase and installation on an appropriate computer system or by using a Web-based printing service provider that takes advantage of the capabilities of the Web and modern Web browsers to provide document design services from any computer with Web access at whatever time and place is convenient to the user. Computerized systems typically provide their customers with the ability to access and view pre-designed product templates, select a desired template, and enter information to create a customized product design.

The use of pre-designed electronic product templates imposes various limitations and constraints on the flexibility of the product design system and its usefulness to many customers. Traditionally, a designer employed by the template provider individually designs each template by defining all of the various details of the template, such as the size and position of all image and text areas in the template; selecting, cropping and positioning images; defining colors to be used for template elements having a color attribute, and so forth. The template designer adjusts the various elements until the designer is satisfied with the overall appearance of the template. User editing is usually limited to allowing the user to add, modify and position text and perhaps upload images to be added to the product design.

Not only is this prior art template design approach time consuming and a significant expense for the template provider, it limits the user's ability to customize the colors used in the product being designed. There is a need for a flexible electronic product customization system that allows a template provider to give users the ability to exercise extensive control over the colors used in the product being designed.

### SUMMARY

The present invention is directed to satisfying the need for computer implemented systems and methods providing flexible electronic product design tools that allow a user increased ability to select and control the colors used in a product being designed.

In accordance with the invention, a grayscale image is treated as a pattern and is used as the pattern fill of a markup language shape. The pattern fill element provides for the specification of two colors to be used in rendering the pattern. One of the two specified colors is applied as the white component of the grayscale image and the other color is applied as the black component, resulting in the pattern being displayed in combinations of the two specified colors. One or more tools are provided to allow a user of the system to select alternate colors to be applied to the pattern.

It is a feature of the invention that the pattern is stored in grayscale format.

It is another feature of the invention that the colors used to create color versions of the grayscale image are determined by the color attributes of the pattern fill element.

It is an advantage of the invention that the colors used to render the pattern can be readily modified by changing the pattern fill color attributes.

It is another advantage of the invention that the template provider does not need to develop and store multiple differently colored versions of a pattern image.

These and other objects, features and advantages of the invention will be better understood with reference to the accompanying drawings, description and claims.

### BRIEF DESCRIPTION OF THE DRAWINGS

FIG. 1 is a block diagram of a computer system with which the invention may be employed.

FIG. 2 is a schematic representation of a product selection display presented to a user engaged in designing an electronic document.

FIG. 3 is a representation of a user display depicting three color control tools.

FIG. 4 is a representation of a user display depicting the use of the first color control tool.

FIG. 5 is a representation of a user display depicting the use of the second color control tool.

FIG. 6 is a representation of a user display depicting the use of the third color control tool.

### DETAILED DESCRIPTION

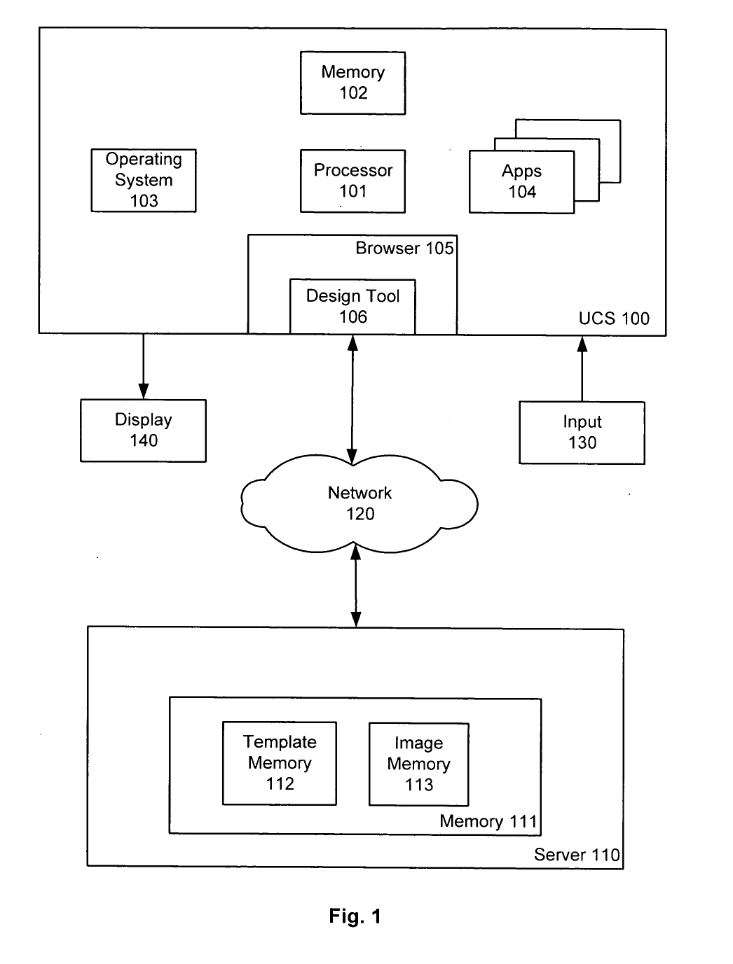

Referring to FIG. 1, an exemplary user computer system UCS 100 includes processor 101 and memory 102. Memory 102 represents all UCS 100 components and subsystems that provide data storage, such as RAM, ROM, and hard drives. In addition to providing permanent storage for all programs installed on UCS 100, memory 102 also provides temporary storage required by the operating system and the applications while they are executing. In a preferred embodiment, UCS 100 is a typically equipped personal computer, but UCS 100 could also be a portable computer, a tablet computer or other device. The user views images from UCS 100 on display 140, such as a CRT or LCD screen, and provides inputs to UCS 100 via input devices 150, such as a keyboard and a mouse.

When UCS 100 is operating, an instance of the USC 100 operating system will be running, represented in FIG. 1 by operating system 103. In addition, the user may be running one or more application programs. In FIG. 1, UCS 100 is running Web browser 105, such as Internet Explorer from Microsoft Corporation. Other applications that may be running in USC 100, such as spreadsheet, e-mail, and presentation programs, are represented as applications 104. In the depicted embodiment, design tool 106 is a product design program downloaded to UCS 100 via network 120 from remote server 110, such as downloadable design tools provided by VistaPrint Limited and publicly available at vistaprint.com. Design tool 106 runs in browser 105 and allows the user to prepare a customized product design in electronic form. Alternatively, design tool 106 could have been obtained by the user from memory 102 or from another local source. When the customer is satisfied with the design of the product, the design can be uploaded to server 110 for storage and, if desired by the user, subsequent production of the desired quantity of the physical product on appropriate printing and post-print processing systems. While server 110 is shown in FIG. 1 as a single block, it will be understood that server 110 could be multiple servers configured to communicate and operate cooperatively.

Memory 111 represents all components and subsystems that provide server data storage, such as RAM, ROM, and disk drives or arrays. Template memory 112 contains the various layout information provided by the service provider to enable the creation and rendering of templates at UCS 100. As used in this embodiment, a layout is an XML (extensible markup language) and VML (vector markup language) description that specifies the size, position, z-index, and other attributes of all product elements such as text containers, image containers, graphics, default fonts, default colors, and so forth. Technical details of XML and VML are publicly available from the World Wide Web Consortium at www.w3c.org. While the embodiment of the invention disclosed herein describes the use of XML and VML, it will be understood that other languages could be employed.

Of particular interest to the instant invention, VML provides for “shape” elements that allow the designer to define and use various common shapes, such as a circle, oval, curve, or rectangle, or to create and use complex custom shapes. VML further provides “fill” sub-elements allowing the designer to fill a shape with various types of content, for example a single color, a gradient, a picture, or a pattern. If the fill content of a shape is identified as a pattern, the pattern fill element specifies two colors to be used to render the pattern.

Image memory 113 represents the portion of memory 111 that contains the content information and related attributes used in combination with the layouts to generate various product designs. Image memory 113 could contain photographs, textures, patterns, graphics, or other such materials made available by the template provider for incorporation into template designs.

Of particular relevance to the current invention are “grayscale” images. As is well known in the art, grayscale images are images containing multiple shades or levels of gray. Depending on the system used to create the grayscale image, from 16 to 256 gray levels will typically be available to render the image, ranging from white at one extreme of the range to black at the other. Tools for creating grayscale images and for converting color images to grayscale are widely available from Adobe Systems Incorporated and other vendors. It will also be understood that the use of the term “grayscale” or “grayscale image” does not necessarily mean that the image is either stored or displayed to the user in gray shades, but rather the terms are used herein more broadly to refer generally to image content intended to be rendered in multiple color tones based on the combination of two component colors.

In a typical RGB computer monitor application, each gray level is rendered by appropriately adjusting the monitor's RGB levels. In a printing application, gray levels are rendered by controlling the relative proportion of the print surface covered with “black” relative to the amount of surface covered with “white”. In printing practice, white is not normally a printed color and grayscale images are often printed using a single color of ink, which of course could be any color, not just black, with the “white” component being the absence of ink such that the color of the underlying paper stock or other surface on which the image is printed is visible. The various intermediate “gray” shades are created by controlling the amount of ink coverage relative to the amount of paper stock allowed to remain uncovered. An area of the image that is “black” is created by fully covering the underlying surface with ink. While grayscale images are generally thought of in terms of shades derived by varying the combination of black and white, any two colors could be used to print a grayscale-type image by assigning a first color to be used in place of “white” and a second color to be used in place of “black” with the intermediate “gray” shades being generated by appropriately controlling the proportions of the first and second colors.

The novel combination of grayscale images with the attributes of markup language shapes provides the user with extensive flexibility to choose colors for these types of images. In the disclosed embodiment, when grayscale images are stored in image memory 113, they are stored as .jpg files and are identified as patterns, allowing the grayscale images to be used as pattern fill for a markup language shape. By using a grayscale image as a pattern fill, the colors used to render the grayscale image can be readily controlled by means of the color attributes associated with the pattern fill element. In this manner, the image can be rendered in an enormous number of color combinations simply by changing the colors associated with the appropriate pattern fill element. In the disclosed embodiment, the image of the product template is generated by design tool 106 in the browser, allowing the user's requested color changes to occur very quickly and avoiding the need for communication with the server. It will be understood by those of skill in the art that alternate embodiments are possible, such as rendering the template image at the server instead of at the client computer.

This flexible template structure mentioned above allows the service provider to assemble custom templates in response to user inputs, such as keywords or other user preferences, and allows the user to select and modify or replace individual template components. Co-pending and co-owned U.S. application Ser. No. 10/646,554 entitled “Automated Image Resizing and Cropping”, filed Aug. 22, 2003, the complete contents of which are hereby incorporated by reference into this application, discloses electronic product creation and editing systems for combining separately stored content and layouts to create custom product designs.

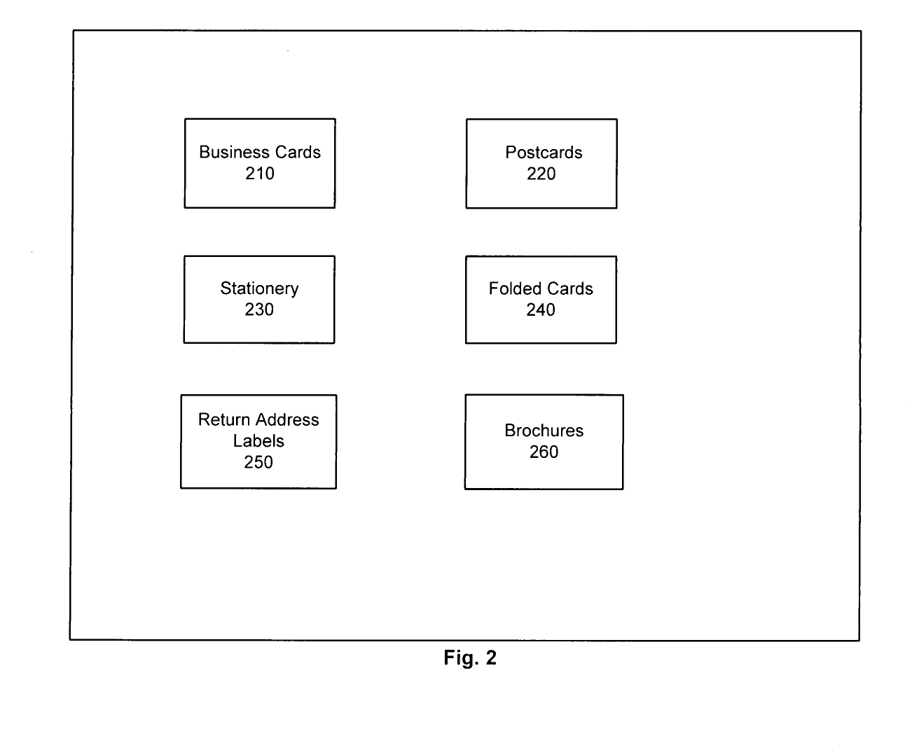

FIG. 2 is a simplified representation of an introductory product selection page being viewed by the user of UCS 100 on user display 140. In this example, the page displays and promotes various products available from the service provider and offers active controls that allow the user of UCS 100 to select a desired type of product for a more detailed presentation of design options. By way of example, FIG. 2 shows promotional images for business cards 210, postcards 220, stationery 230, folded cards 240, return address labels 250, and brochures 260. Images or promotions for fewer, different or additional products, such as presentation folders, invitations, announcements, thank you cards, gift tags, and so forth could also be presented along with other information and buttons. It will be understood that the invention is not limited to documents that are intended for eventual printing. The invention is also applicable to the design of documents intended for use in electronic form, such as electronic business cards, online brochures, and templates for presentation graphics software programs. The invention could as well be readily adapted to a wide range of products that a user may wish to customize, such as items of clothing, product containers, promotional goods, and so forth.

As an illustrative example, it will be assumed that the user of UCS 100 desires to create a personalized postcard and, therefore, selects the postcard option, for example by clicking with the user's mouse cursor on the postcards 220 image. The user will then be presented with one or more additional selection screens, not shown, from which the user can review the various postcard categories by general theme or subject matter and then, when the desired category is selected, review one or more pages of thumbnail images of postcard templates prepared by the service provider. As an alternative to providing a large gallery of thumbnail template images for the user to scan, the service provider could provide a keyword searching tool to allow the service provider to display only thumbnails of templates with images or other content corresponding to the user's search terms.

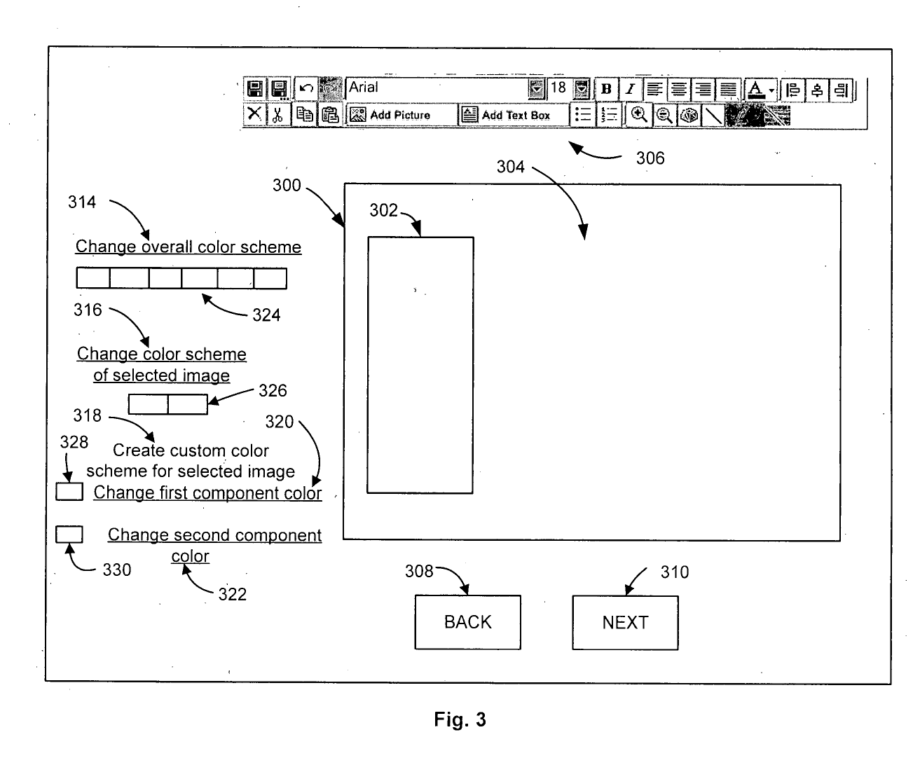

Referring to FIG. 3, when the user selects a specific template thumbnail that the user desires to customize, server 110 responds to the selection by downloading the corresponding layout and content information to UCS 100. Design tool 106 receives the layout and content information and generates a customizable template image 300 of the selected product design, which could contain a wide variety and number of images, colors, graphics, and other design elements.

For simplicity of discussion, in the example shown in FIG. 3, template 300 represents one side of a postcard being designed by a user. The design contains two image containers, also referred to herein as image areas: a background image area 304 covering the entire side of the postcard template and smaller image area 302 that appears over image 304. As used herein, an image area is intended to be read broadly to indicate a container that could contain a wide variety of possible non-text content, such as a photograph, graphic, texture, pattern, word art, or the like. As mentioned above, the template 300 displayed to the user is the result of the combination of various separately stored template component elements including container content information and the layout specifying the size and position of the containers. The initial template 300 is the starting point for the user's customized product design. The user can not only add the user's personalized text and additional images, but can also, as discussed below, modify the colors used for image containers containing grayscale content.

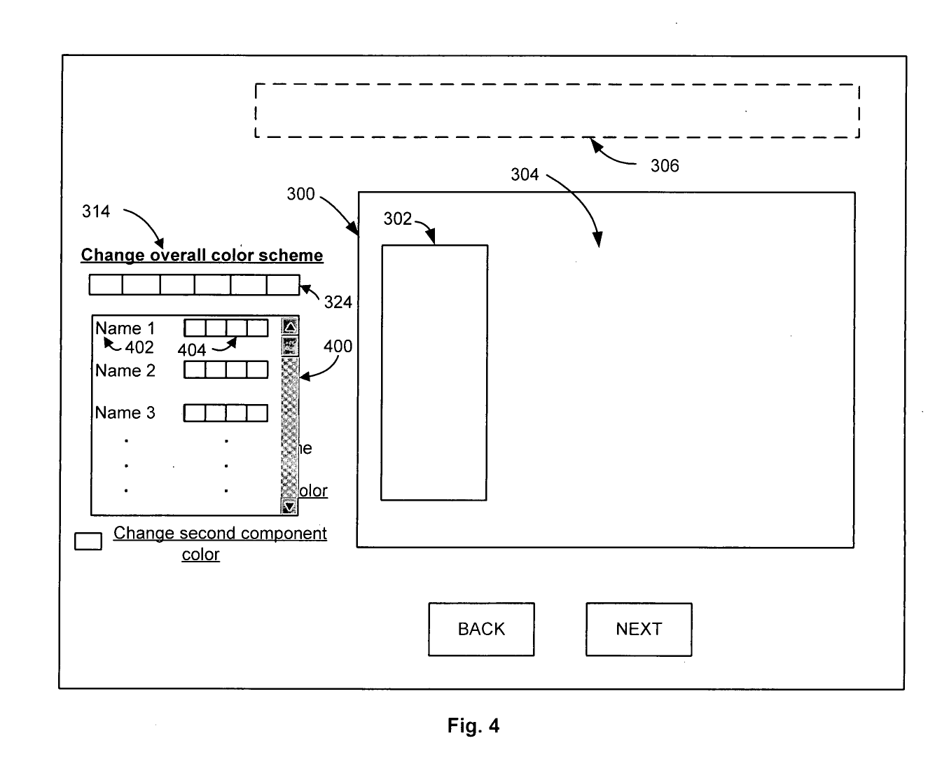

To allow the user to customize the product design, the user is provided with template editing tools. Edit Tool Bar 306, depicted as a dashed box in FIGS. 4-6, contains various buttons, controls and menus allowing the user to add additional text boxes, insert text, change the font, change font attributes, and perform other typical editing actions. The techniques for designing and using edit tool bars are well known in the art. Navigation buttons Back 308 and Next 310 allow the user to move back to the previous display screen or ahead to the next. Different or additional navigation means could also be employed.

As will be discussed below, FIG. 3 depicts three different color control tools, each tool being an application of the current invention, for allowing the user to modify colors used in template 300. For the purposes of discussing alternate applications of the invention, FIG. 3 shows all three tools being simultaneously displayed to the user. It will be understood that it is not necessary to employ all three tools. A service provider could opt to provide only a single tool or a combination of tools, depending on the level and type of color control the service provider desires to provide to users. Depending on the level of customizing capabilities the service provider desires to give to the user, the service provider may also choose to provide the user with one or more additional instructions, tools, or controls, not shown, to facilitate user editing of template 300, such as tools for changing the template layout, the design effects, or the font scheme. Co-pending and co-owned U.S. application Ser. No. 10/449,836 entitled “Electronic Document Modification”, filed May 20, 2003, the complete contents of which are hereby incorporated by reference into this application, describes a document editing system and method using separately selectable layouts, designs, color schemes and font schemes.

In a first tool, “Change overall color scheme” 314 is a text button that, when selected by the user, presents a number of available pre-designed alternate product color schemes. The user can select one of the color schemes to be applied to the entire product being designed. Color scheme 324 displays to the user the color scheme currently used in template 300. Color scheme display 324 is depicted with six separate color sections in FIG. 3, but it will be understood that the number of different colors in individual color schemes are determined by the service provider and the service provide could choose to display more or fewer individual color scheme sections. Button 314 allows the user to change the color scheme of the entire product being designed, including all elements of the template design having a color attribute, such text, word art, graphic elements, and so forth. Button 314 is active whether or not a particular image area of the template has been specifically selected by the user.

In the second depicted tool, “Change color scheme of selected image” 316 is a text button that, when selected by the user, presents a number of available pre-selected color pairs. The user can select a pair to replace the pair of colors currently applied to a selected image area in template 300. Button 316 and color pair 326 will not be active unless an image area having appropriate grayscale content has been selected by the user. When an image area of template 300 containing grayscale content is selected, color pair 326 will show the pair of colors currently used in the selected image area.

In the third tool, “Create custom color scheme for selected image” is an informational notice informing the user of the purpose of buttons “Change first component color” 320 and “Change second component color” 322. Buttons 330 and 322 and color blocks 328 and 330 will not be active unless an image area having appropriate grayscale content has been selected by the user. When an image area of template 300 containing grayscale pattern content is selected, color block 328 displays the current color associated with a first color component of the pattern in the selected image area in template 300 and color block 330 displays the current color associated with a second component color of the selected image.

Referring to FIG. 4, button 314 will be discussed. After the user has clicked on button 314, the button is highlighted, indicated by bold letters in FIG. 4, and scrollable color scheme table 400 is displayed to the user. Table 400 contains a number of available color groups or schemes pre-selected by the service provider. For each color scheme 404, the table displays an arbitrary identifying name 402, such as Caribbean, Harvest, or Sassy, to assist the user in remembering and identifying a particular color scheme that the user may have used in the past. The table also displays the individual colors in the color scheme. In the disclosed embodiment, black and white are two standard component colors of all color schemes. Black and white color sections are displayed in color scheme 324, but only the variable colors of each color scheme are displayed in individual color scheme sections 404. The user selects a new color scheme by maneuvering the mouse cursor over a desired scheme and selecting it with a single click. Upon selection of a new color scheme, the selected scheme is applied to all elements of template 300 having a color component, table 400 is closed, and color scheme 324 is updated to reflect the newly selected color scheme. With this tool, the template provider will have pre-selected two of the colors in the color scheme to be applied to the grayscale image in the template. If multiple grayscale images are used, the template provider could apply a different pair of colors from the color scheme to each different grayscale image.

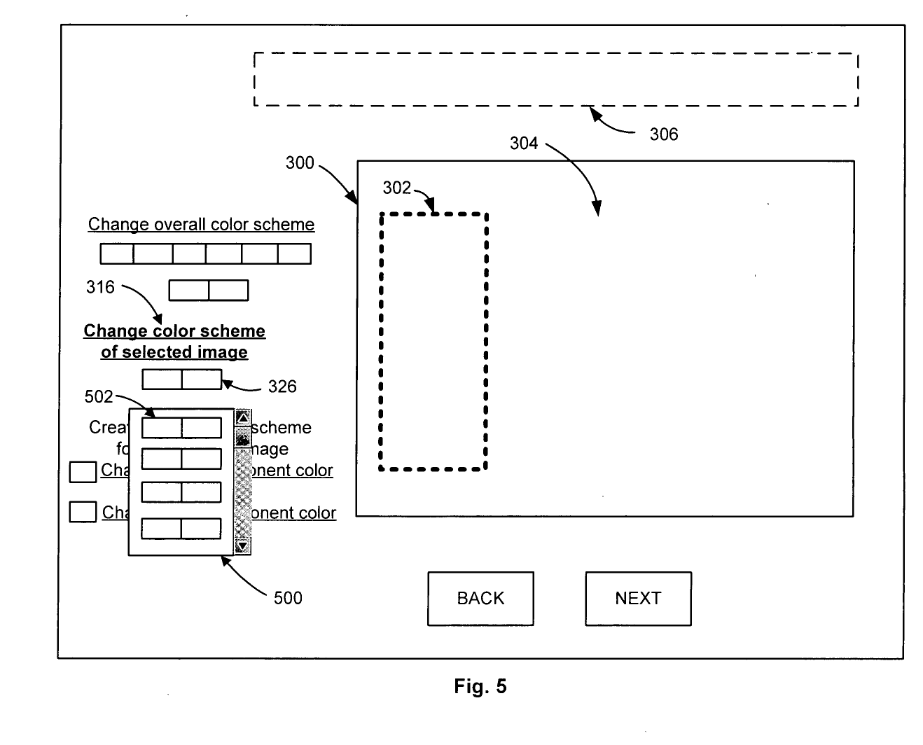

Referring to FIG. 5, the operation of button 316 will be discussed. In the depicted situation, the user has selected image area 302 by double clicking with the user's mouse while the mouse cursor was positioned over image area 302. To provide visual feedback to the user that the area is in a selected condition, image area 302 is displayed with a distinctive border, indicated in FIG. 5 by dashed lines. The color pairs will be applied to a selected container having a pattern fill. Button 316 is inactive unless an appropriate pattern fill container has been selected by the user for editing. If a pattern fill container is not currently selected, the inactive state of button 316 is visually indicated to the user, for example by displaying the button in light gray, not shown.

If the selected image area is a shape having a pattern fill, button 316 becomes active. In the situation depicted in FIG. 5, the user selected image area 302 and then clicked on button 326, indicating a desire to change the colors of the contents of image area 302. Button 316 is highlighted, indicated by bold letters in FIG. 5, and scrollable color pair table 500 is displayed to the user. Table 500 contains a number of available groups of colors, each group being a pair of colors pre-selected by the service provider as being attractive or compatible. For each color pair 502 in table 500, an identifying name (not shown) could be employed, if desired. Upon selection of a new color pair from table 500, the selected colors are applied as the color attributes of the pattern in the selected image area, table 500 is closed, and color pair 326 is updated to reflect the newly selected color pair. Image area 302 will remain selected, so the user can again select button 316 and select another color pair, if the user desires. In response to a change by the user in a selected image area, the template provider may choose to retain all other colors in template 300 unchanged or may opt to make changes to other components of template 300 to maintain compatibility with the new colors selected by the user.

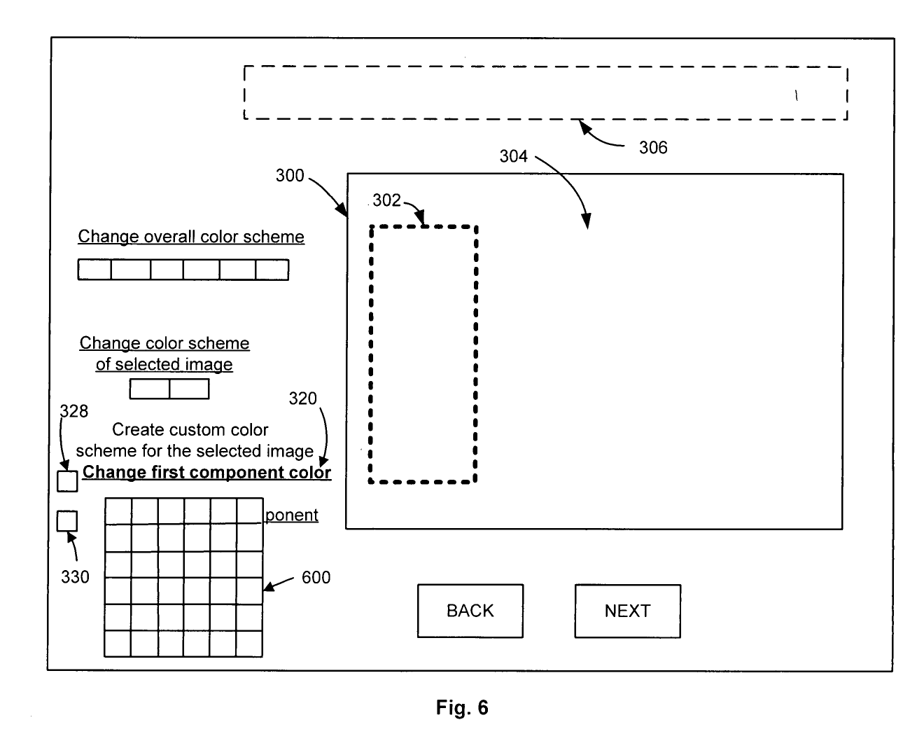

Referring to FIG. 6, the operation of button 320 will be discussed. As discussed above in connection with FIG. 5, the user has selected image area 302 and the selected status of the image area is indicated by a distinctive border, indicated in FIG. 6 by dashed lines. Like button 316, buttons 320 and 322 will be active only if the selected image area is a shape having an associated pattern fill. If a pattern fill container having a pattern is not currently selected, the inactive state of button 316 is visually indicated to the user, for example by displaying the button in light gray (not shown).

If the selected image area is a shape having a pattern fill, buttons 320 and 322 become active. Color section 328 will display one of the two colors currently associated with the pattern in the selected image area and 330 will be display the other. In the situation depicted in FIG. 6, the user selected image area 302 and then clicked on button 320, indicating a desire to change the first component color of the content of image area 302. Button 320 is highlighted, indicated by bold letters in FIG. 6, and color selection palette 600 is displayed to the user. While palette 600 is shown in FIG. 6 as a 6-by-6 array of color sections, it will be understood that the service provider will typically choose to present a palette with many more colors selectable by the user. Various color selection tools and formats are well known in the art.

Upon selection of a new color from palette 600, the selected color is applied as the first color attribute of the pattern in the selected image area, palette 600 is closed, and color section 328 is updated to reflect the newly selected color used in the image area. The pattern in the selected image area will be based on the newly selected first color and the existing second color, allowing the user the freedom to use any desired pair of available colors. Image area 302 will remain selected, so the user can again select button 320, or button 322, and select another color, if the user desires. In response to a color change by the user in a selected image area, the template provider may choose to retain all other colors in template 300 unchanged or may opt to make changes to other components of template 300 to maintain compatibility with the new color selected by the user. Button 322 allows the user to select a new second component color while retaining the current first component color. Button 322 operates in the same fashion as button 320 and will not, therefore, be separately discussed.

The user can continue to modify colors or make other modifications until the user is satisfied with the design of template 300. The user can then, using Next button 310, move on to other screens, not shown, to take additional actions as may be appropriate to the particular product being designed, such as customizing another side of the product, requesting that the design be saved for later use or review, or making arrangements to create printed copies of the designed product.

Various illustrative embodiments have been discussed, but other alternate embodiments could also be employed. For example, it will be understood that while embodiments of the invention have been disclosed in the context of tools for editing an electronic product design, it will be understood that the invention is not so restricted and can be independently employed in other situations where the manipulation and control of colors for grayscale-based images is desired. Therefore, the described embodiments are to be considered as illustrative rather than restrictive and the scope of the invention is as indicated in the following claims and all equivalent methods and systems.

1. A computer-implemented method for generating a color image in a computer browser program, the method comprising:
associating at least one color with a markup language element capable of accepting content,
applying a grayscale image as content of the element, and
modifying the content image by applying the at least one color associated with the element as at least one color component of the content image.

2. The method of claim 1 further comprising:
displaying at least the modified content image to a user of the computer browser program,
providing a plurality of color groups,
allowing the user to select a group from the plurality of groups,
after the selection of a group by the user, modifying the content image by replacing at least one of the color components of the content image with at least one of the colors in the selected group, and
displaying the newly modified content image to the user.

3. The method of claim 1 further comprising:
displaying at least the modified content image to a user of the computer browser program,
providing a color palette containing a plurality of individually selectable colors,
allowing the user to select a color from the palette,
after the selection of a color by the user, modifying the content image by replacing one of the color components of the content image with the selected color, and
displaying the newly modified content image to the user.

4. The method of claim 1 wherein the element is a shape and the grayscale image is applied as pattern fill content of the shape.

5. The method of claim 1 further comprising:
incorporating the content image into an electronic product design, and
displaying the electronic product design to a user.

6. A color image system for use with a computer executing a browser program, the system comprising:
one or more grayscale images,
one or more markup language elements capable of accepting content and having at least one associated color attribute, and
means for applying a grayscale image as content of an element such that the at least one color attribute of the element is applied as at least one color component of the content image.

7. The system of claim 6 further comprising:
at least one color selection tool,
means for allowing a user to select at least one color with the color selection tool, and
means for applying the at least one selected color as at least one color component of the content image.

8. The system of claim 6 wherein the element is a markup language shape and the grayscale image is applied as a pattern fill of the shape.

9. The system of claim 6 further comprising:
means for incorporating the content image into an electronic product design, and
means for displaying the electronic product design to a user.

10. A color image generation program adapted to execute in a browser program running on a computer, the program comprising:
computer code adapted to apply a grayscale image as content of a markup language element capable of accepting content and having at least one associated color attribute such that the at least one color associated with the element is applied as at least one color component of the content image.

11. The program of claim 10 further comprising:
computer code adapted to display at least the content image to a user of the computer,
computer code adapted to display at least one color selection tool to the user, and
computer code, responsive to the selection of one or more colors by the user, adapted to modify the content image by applying the one or more selected colors as one or more color components of the content image.

12. The program of claim 10 further comprising:
computer code adapted to incorporate the content image into an electronic product design, and
computer code adapted to display the electronic product design to the user.

13. A color image generation program stored on a server system and adapted to download to a user computer and execute in a browser program of the user computer, the program comprising:
computer code adapted to apply a grayscale image as content of a markup language element capable of accepting content and having at least one associated color attribute such that the at least one color associated with the element is applied as at least one color component of the content image.

14. The program of claim 13 further comprising:
computer code adapted to display at least the content image to a user of the computer
computer code adapted to display at least one color selection tool to the user, and
computer code, responsive to the selection of one or more colors by the user, adapted to modify the content image by applying the one or more selected colors as one or more component colors of the content image.

15. The program of claim 13 further comprising:
computer code adapted to incorporate the content image into an electronic product design, and
computer code adapted to display the electronic product design to the user.

16. A computer-implemented method of displaying an electronic product design at a computer executing a browser program, the method comprising:
receiving electronic product design information, the information including at least one markup language element capable of accepting content, at least one grayscale image, and identifiers of a plurality of colors, and
processing the received information in the browser program to display an electronic product design to a user, the electronic design including at least one element filled with a color image generated by replacing at least one color component of the grayscale image with at least one color from the plurality of colors.

17. The method of claim 16 further comprising:
allowing the user of the computer to select one or more colors from the plurality of colors,
after selection of the one or more colors, modifying the product design by applying the one or more user-selected colors as one or more color components of at least the color image, and
displaying the modified displayed electronic design to the user.
